(19) United States
(12) Patent Application Publication
(10) Pub. No.: US 2009/0070188 A1
(43) Pub. Date: Mar. 12, 2009

(54) PORTFOLIO AND PROJECT RISK ASSESSMENT

(75) Inventors: David Scott, Kent (GB); Divya Anand, Kent (GB); Andrew Smithies, Kent (GB)

Correspondence Address: FISH & RICHARDSON P.C., P.O. BOX 1022, MINNEAPOLIS, MN, 55440-1022, US

(73) Assignee: Certus Limited (UK), Kent (GB)

(21) Appl. No.: 11/851,897

(22) Filed: Sep. 7, 2007

(51) Int. Cl. G06Q 10/00

(52) U.S. Cl. 705/10

(57) ABSTRACT

A system and method are provided for portfolio risk assessment. A user is prompted for answers to one or more questions that each relate to the risk of aspects of a project. The questions may take the form of a customized questionnaire, and the answers may be quantitative or qualitative. Compounding effects among the questions are identified. Based on these compounding effects, a compound risk score for the project is generated. In some implementations, correlating effects between projects are also identified. Based on these correlating effects, a correlated risk score for a project is generated. Some implementations may generate output data that allows a user to view projects individually and in combination to highlight compounding and correlating effects.

### TECHNICAL FIELD

This disclosure relates to portfolio and project risk assessment.

### BACKGROUND

Risk management relates to integrating recognition of risk, risk assessment, development of strategies to manage risk, and mitigation of risk using managerial resources. Some strategies employed to manage risk include transferring the risk to another party, avoiding the risk, reducing the negative effect of the risk, and accepting some or all of the consequences of a particular risk. The risk management process relies, to an extent, on accurate identification and assessment of risks.

An objective of risk management in the context of projects (e.g., capital expenditures, research endeavors, investments, endeavors, undertakings, and the like) relates to identifying the risk associated with a particular project and as compared to other projects. Management often uses the comparison of risks to select which projects are undertaken. In corporations, risk management is sometimes referred to as Enterprise Risk Management (“ERM”).

### SUMMARY

An aspect of the present invention relates to portfolio risk assessment. A user is prompted for answers to one or more questions each of which relates to the risk of aspects of a project. The questions may take the form, for example, of a customized questionnaire, and the answers may be quantitative or qualitative. Compounding effects among the questions are identified. For example, a user and/or the system may identify questions that relate to aspects that increase (or decrease) the risk of another aspect associated with another question within the project. Based on these compounding effects, a compound risk score for the project is generated. In some implementations, correlating effects between projects are also identified. For example, a user and/or the system may identify questions that relate to an aspect of a second project that increases (or decreases) the risk of an aspect of the first project. Based on these correlating effects, correlated risk scores for the projects are generated. Some implementations generate output data that allows a user to view projects individually and in combination to highlight compounding and correlating effects.

The details of one or more implementations are set forth in the accompanying drawings and the description below. Various features and advantages will be apparent from the description and drawings, and from the claims.

### BRIEF DESCRIPTION OF DRAWINGS

FIG. 1 is a flowchart of a implementation of a methodology for project risk assessment.

FIG. 2 is a graph comparing risk scoring methods across example projects.

FIG. 3 is a graph comparing risk scoring methods for an example project.

FIG. 4 is a Pareto graph comparing projects against a benchmark.

FIG. 5 is a Pareto graph comparing projects in a baseline view.

FIG. 6 is a graph illustrating the depicted risk (e.g., the output provided to a user) for a range of answers.

FIG. 7 is a graph illustrating the effect of the Comparison Value.

FIG. 8 illustrates an example of a risk assessment system.

FIG. 9 illustrates an example of a method of interacting with a risk assessment system.

FIG. 10 is a flowchart depicting an example of a risk assessment methodology.

FIG. 11 is an example screenshot of questions that may be prompted to a user of a risk assessment system.

FIG. 12 is an example screenshot of a Score Matrix that may be provided to a user of a risk assessment system.

FIG. 13 is an example screenshot of a Correlation Matrix that may be provided to a user of a risk assessment system.

FIG. 14 is an example of a Pareto graph comparing projects with Ranking Scores.

FIG. 15 is an example of a Pareto graph comparing projects with Balanced Base Scores.

### DETAILED DESCRIPTION

The following is a description of preferred implementations, as well as some alternative implementations, of project risk assessment.

Some implementations aid personnel (e.g., senior managers or divisional/project managers) in the identification and comparison of risks among and between projects. The system and method may allow easy recall and comparison with previous projects. Various implementations are based on a computational and analytic framework, and may be enhanced by management knowledge, experience and judgment.

Some implementations provide a measurement mechanism for management to improve financial returns commensurate with opportunity and risk. Input data is received that takes account of qualitative and quantitative characteristics of a project. The data then is evaluated and output data is generated in a numeric and graphical manner. The output data can be used to provide consistent, numerical data for statistical and other forms of quantitative analysis of the risks and performance of projects and organizations.

By scoring across a range of opportunity and risk factors it is possible to view prospective and actual projects individually and in combination to highlight, e.g., (i) the collective effect of common factors, (ii) the additive effect of multiple projects (sometimes called the “portfolio effect”) or (iii) the result of systemic or correlated risk. Project combinations can be by any identifiable group, e.g., prospective against actual, by type, by division or corporate.

Analyzing and comparing projects in these (and other) combinations offer benefits at each organizational level, from project level up to the corporate level. At the project level, benefits may include, e.g., (i) improved identification and pricing of riskier projects, (ii) enhanced returns from positive management of higher risk projects from the outset, (iii) pricing and suitability of prospective projects judged against a structured benchmark of all (or selected) historic, current or proposed projects, (iv) establishment of an historic project database, (v) evaluation of compound risks, i.e., the interaction of risk characteristics that may have a positive or negative impact on the overall project risk, (vi) monitoring project performance over time and/or (vii) encouragement of better manager performance.

At the divisional level, benefits may include, e.g., (i) creation of a measurement mechanism to help manage the divisional portfolio and shape future business, (ii) enhanced risk versus return trade-off, (iii) monitoring of the divisional risk profile and the effect of individual projects, (iv) improved identification of and ability to exploit market opportunities and/or (v) better analysis of risk trends across all projects in division.

At the corporate level, benefits may include, e.g., (i) creating an objective picture of the corporate portfolio, (ii) creating a “snapshot” portfolio analysis on a regular basis (a way to see and address/mitigate changes), (iii) providing a measurement mechanism to help direct and shape corporate business, (iv) better assessment and measurement of the corporate underlying risk and exposures, (v) improved identification of key trends and issues, (vi) provision of a more effective flow of risk information between project, division and corporate levels, (vii) easier quantification of project risk exposures, (viii) greater appreciation of risk weighting, correlation, and extreme risk, (ix) providing correlation analysis (both positive and negative), (x) providing a prospect analysis tool (e.g., a prospect can be compared to corporate history) and/or (xi) establishment of “a corporate memory” or central repository of information that enables management to look at risk in a broader context, spot trends and realize hidden potential risks (e.g., correlated risks).

### Computational and Analytical Overview

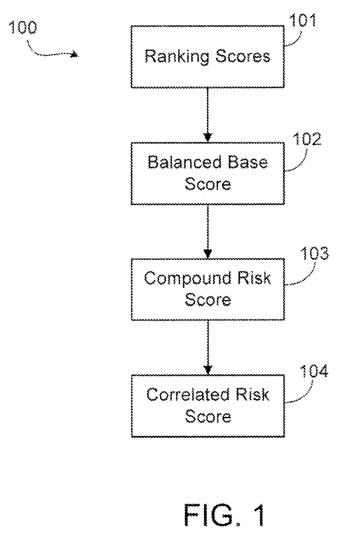

FIG. 1 illustrates an implementation of a methodology 100 for aggregate project risk assessment. Aspects include: (i) determination of ranking scores (101); (ii) determination of the balanced base score (102); (iii) determination of the compound risk score (103) and (iv) determination of the correlated risk score (104).

### Ranking Score

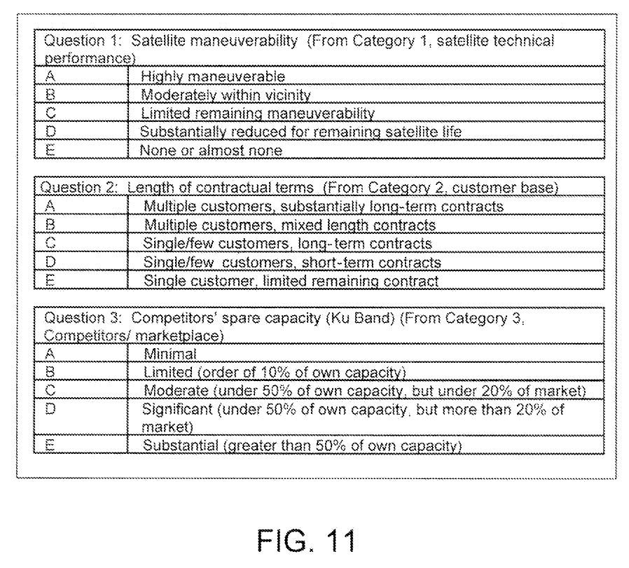

The starting point of the risk assessment process is the development of a tailored questionnaire that categorizes risk (an example of such a questionnaire is discussed in connection with FIG. 11). Each question may relate to one or more aspects of a project that relate to risk. Each aspect may be, for example, as narrow as the particular driver circuit used in a satellite system (since different circuits may affect performance or have different reliability) or as broad as a project's overall budget. In some implementations, it is preferred that the questionnaire be developed closely with the party whose risk is being analyzed (e.g., a client). In some implementations, questions on the questionnaire are weighted relative to each other, either individually or in groups or categories. These weights are determined based on the potential financial impact, volatility, and level of control with respect to the topic being assessed by the question. A Bayesian network may also be used to map and test the relationship between the individual questions and categories and hence in deriving suitable risk weights. In most applications the weights will sum to 100%. All questions, categories and weights used here and later in the process may be mapped, reviewed and tested over time using statistical, Bayesian, analytical and/or expert review. Other implementations may focus on features other than financial impact, such as, e.g., political impact or environmental impact.

Depending on the particular implementation, some of the questions can be the multiple-choice type, the answers to which can be a number on a integer scale (e.g., 1-6). Other questions may have numerical responses (e.g., revenue, cost, interest rate, term), while others may have more complex answers that are, for example, derived from several simpler questions. Some questions may have purely qualitative responses (e.g., business type, name of vendor, customer or supplier). Answers may be assigned the same ranking as another, and may have a non-integer value (e.g., 1.5).

To provide a common basis for answers to be compared with one another and relative risk level assessed, various mathematical transformations and calculations are undertaken to provide a Ranking Score for each answer. As a result, some implementations provide a risk assessment against an agreed-upon normal risk level (or “norm”) for similar projects (e.g., derived from history and/or experience) in a consistent and mathematically useful way.

In this implementation, to provide a norm for each risk, a fixed mathematical Comparison Value (CV) is defined for each question. To avoid complications in the mathematics (discussed later), the CV preferably avoids negative values. As a result, the norm preferably is not zero.

Therefore, the first transformation is to re-score the answers to have 0 as the minimum value. For example, answers A, B, C, D, E and F are assigned values 0, 1, 2, 3, 4, 5 respectively.

Once the CV is established, all other values are measured relative to this CV and the minimum value. If a CV is defined as 0.5 then the answers again are re-assigned values as multiples of the CV. For example, in the sample case, the answers become 0, 2, 4, 6, 8, 10. This allows the answers to be scaled according to multiples of the CV. The answer with the minimum value is equal to 0 and the answer with the maximum value is a multiple of the CV, with the value at the CV now equal to 1.

An analogous methodology is used with respect to questions with numeric values, e.g., revenue. A CV is defined and all values for use in the system are determined as multiples of the CV. For example, a revenue value of $1,000,000 may be defined as the CV, and any responses are scaled to be multiples of that CV. Note that some numerical values are already scaled to have 0 as the minimum value.

In some circumstances, depending on the type of question, a mathematical transformation may have to be applied prior to the calculation to allow the results to be fairly compared. For example, to deemphasize extreme values, the log of values may be first computed before applying the CV calculations. To emphasize extreme values, answer values are transformed using, e.g., an exponential.

In other types of questions, the answers do not naturally start at zero. In some questions, the answers may need to be normalized to bring them within a 0 to 1 scale. One approach for normalizing involves subtracting the minimum value from the actual value (i.e., the answer) and dividing the result by the range (i.e., the difference between the maximum or an ascribed upper value and the minimum value). An example of a formula for such normalization is:

$$Normalized Value = \frac{Actual Value - Minimum Value}{Range}$$

For example, with respect to the Fahrenheit temperature of water, if the actual temperature is 76° and it is known that the water is in liquid form (therefore a minimum value of 32° and a maximum value of 212°) the normalized temperature is:

$$\frac{76 - 32}{212 - 32} = 0.244$$

A normalized CV is calculated in the same way. If the agreed CV for the water temperature is 68°, then the normalized CV will be:

$$\frac{68 - 32}{212 - 32} = 0.2$$

The Ranking Score then is calculated in a similar manner:

$$Ranking Score = \frac{Normalized Value}{Normalized CV}$$

$$or$$

$$Ranking Score = \frac{( Actual Value - Minimum Value ) / Range}{( CV - Minimum Value ) / Range} .$$

This calculation brings the results of all questions into a comparable scale: 0 to 1 values are below the norm (i.e., the CV) and values greater than 1 are above the norm. In the water example discussed above, the Ranking Score for this answer is:

$$\frac{0.244}{0.2} = 1.222 .$$

In this example, if hotter water is “riskier” (e.g., a process wherein water is used as a coolant, and higher temperatures represent riskier operation of the process), then as a relative risk the actual water temperature (being greater than 1) is a higher risk than the norm.

When the CVs for each question are set at approximately the average or modal values, the total risk score for a completely “average” project (after each of the individual question scores have been multiplied by their appropriate weight) will also sum to one (or 100 in percentage terms) times the sum of the weights (which will normally be 1 or 100%). Percentages may be referred to in some implementations as “Risk Index Units”. Those projects that are generally more risky in most questions will have a total Ranking Score greater than one (100%) and those generally less risky will score less than one (100%).

It is useful, in some risk management implementations, to provide a risk management reference or “yardstick” between projects, divisions, departments, operating units and the like. The CV should, in some implementations, remain a fixed, mathematical element within the calculations of risk scores. This is because, among other reasons, CVs would otherwise be too variable to be of long-lasting use.

Therefore, in order that the underlying mathematics are not affected by such changes, a separate Benchmark Value can be agreed to by management, for example, so that a graphical representation of risk ‘above’ and ‘below’ the ‘typical’ project can be generated. The Benchmark Value operates at overall project level rather than at a question and answer level like the CV. The Benchmark Value can be varied by divisions, departments, operating units and the like without affecting the basic math.

It is useful, for some implementations, to enhance the Ranking Score to create a Balanced Base Score to provide a logic to the mathematics and give a clear presentation of comparative risk scores for Compound and Correlated Risk. The Balanced Base Score process, in some implementations, moves the risk score from a linear scale to an exponential scale.

The Balanced Base Score provides a consistent mathematical basis and methodology across basic Risk Scores, Compound Risk Scores, and Correlated Risk Scores. As a result, the user is provided with a consistent, fixed measurement and scaling across the presentation of results of the risk management analysis, reducing the chance of misinterpretation. The use of such a relative scale has the effect of emphasizing the score for the worst risks. When the user is provided with the output of the analysis, this allows projects carrying heightening risks to be highlighted.

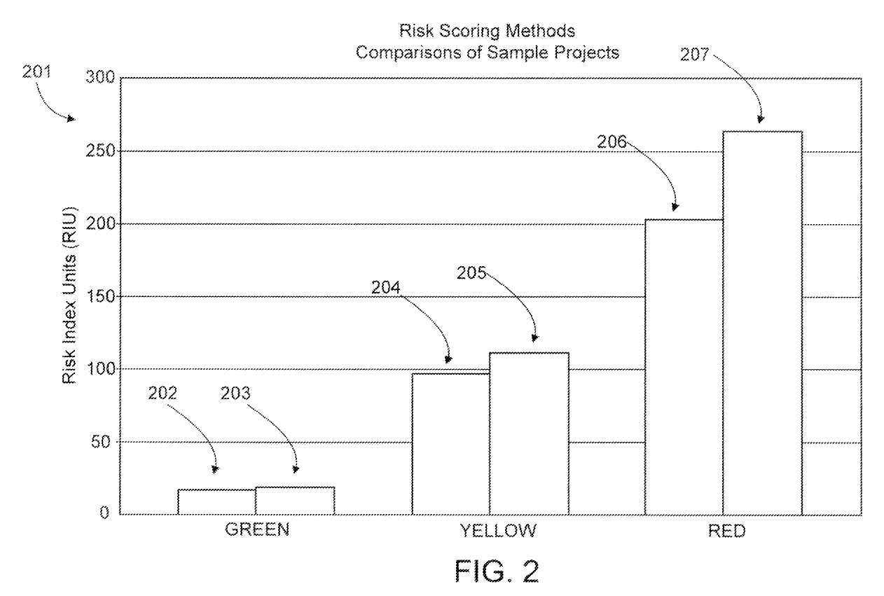

FIG. 2 is a graph of three projects. The Green project represents a relatively low risk project, the Yellow project represents a relatively moderate risk project and the Red project represents a relatively high risk project. The Y-axis 201 represents risk in terms of Risk Index Units. The graph demonstrates the impact of using the Balanced Base Score compared with Ranking Score. The Green project is relatively low risk, and its Balanced Base Score 203 is approximately the same as its Ranking Score 202. The Yellow project is relatively moderate risk, and its Balanced Base Score 205 is moderately higher than its Ranking Score 204. The Red project is relatively high risk, and its Balanced Base Score 207 is substantially higher than its Ranking Score 206. Accordingly, the Balanced Base Score emphasizes higher risk projects and provides output to the user that draws attention to such higher risk projects.

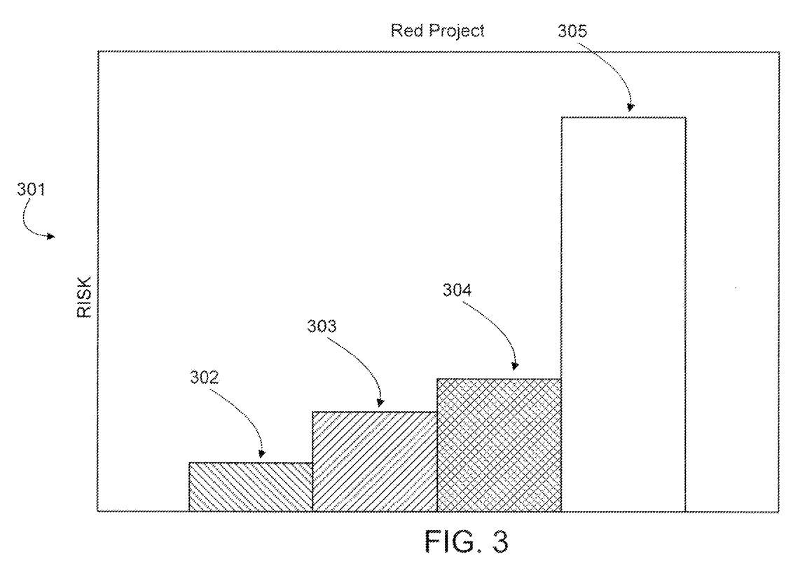

FIG. 3 demonstrates the increased sensitivity of the risk score (illustrated on the Y-axis 301) when moving from Ranking Score 302 to a Balanced Base Score 303 for a high-risk project (in this case, the Red Project). The Compound Score 304 reflects even higher risk as there are many “bad” risk elements within the project that through their interaction multiple (compound) the overall risk. Finally, when moving to Correlated Risk Score 305, the effect of correlated risks within the entire portfolio further increase the risk element on the project.

Both the Ranking Score and the Balanced Base Score use the agreed Comparison Value (CV) of 1 (100%) and the ratio between 0 (0%) and 1 (100%) remains the same. As a result, the scaling remains relative to the same yardstick—the CV. However, in some implementations the Ranking Score typically ranges between 0 (0%) and 5 (500%), but the Balanced Base Score—where the successive scores have a relative relationship with each other—typically ranges between 0 (0%) and 7.5 (750%). As pointed out above, this also has the desirable effect of emphasizing the higher risk elements.

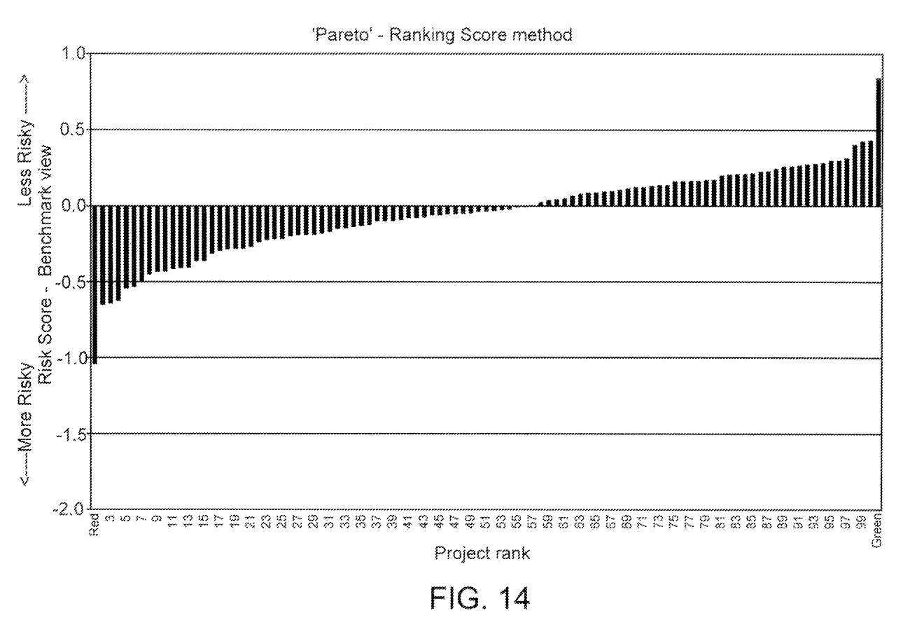

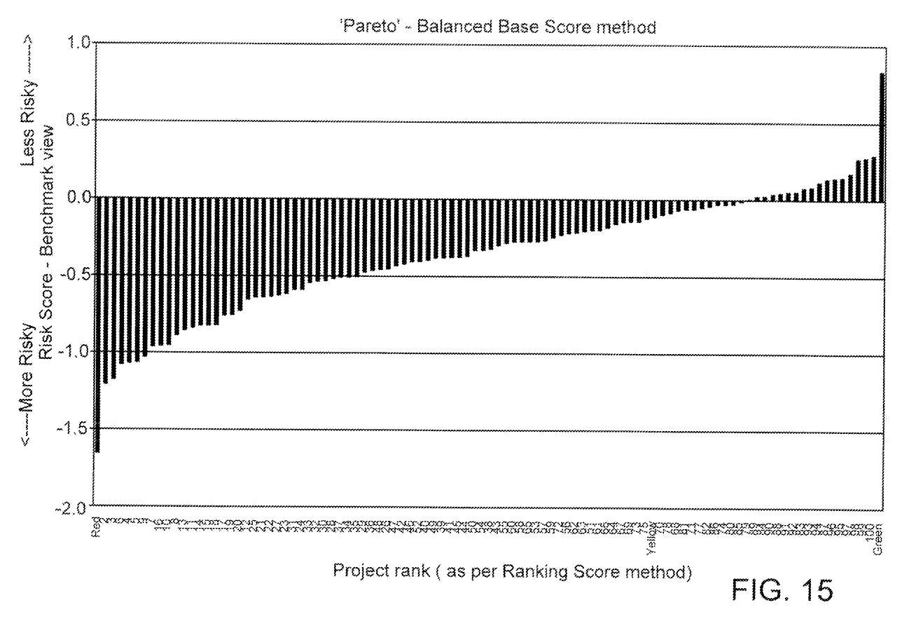

A comparison of Ranking Scores and Balanced Base Scores of projects are shown in the Pareto graphs of FIGS. 14 and 15. Generally speaking, a Pareto graph is a bar chart in which the projects are arranged in the order of their scores, starting with the lowest score. This helps to reveal what are the most important factors in any given situation, and enable a realistic cost-benefit analysis of what measures might be undertaken to improve performance.

In some implementations, the general position of all the projects remains the same, however, individual projects may move up or down a few places in comparison with other projects with apparently similar levels of risk. This reflects the fact that, under the Balanced Base Score method, projects that have more extreme answers will have a higher risk score assigned than those projects with lower amounts of relative risk spread over a wider range of answers. Generally speaking, few projects move relative position but, where they do, the system is indicating the presence of specific, extreme risks that need to be identified.

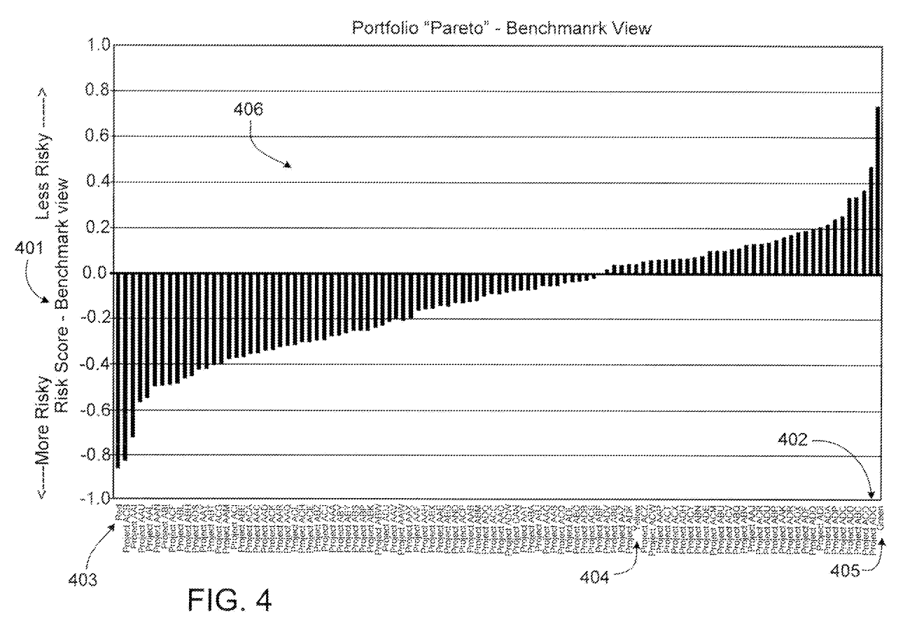

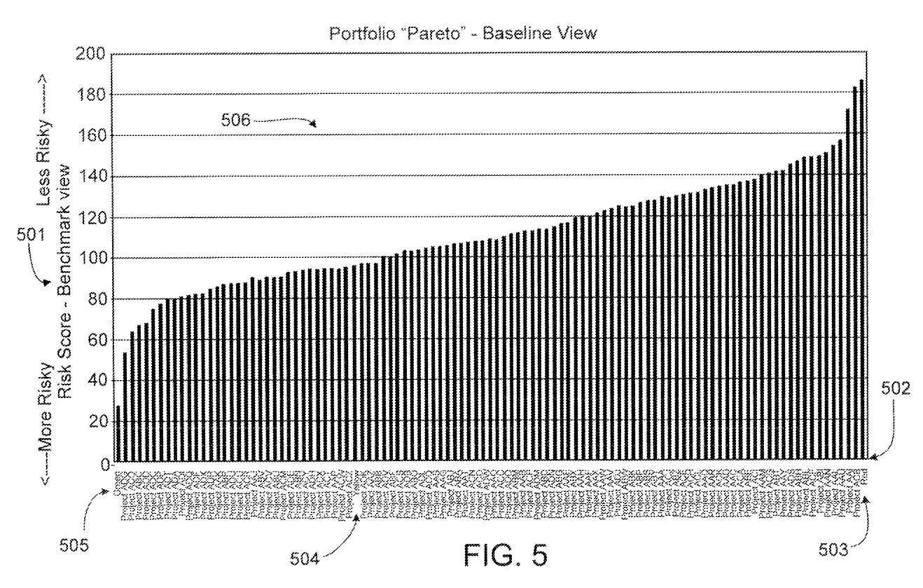

Depending on the circumstances and/or use of an implementation, risk scores can be presented in at least two ways. These presentations are illustrated in FIGS. 4 and 5. First, risk scores can be presented relative to Benchmark Values set by divisions or at corporate level. Projects with a score more risky than the set benchmark will have a negative score and those that are less risky will have a positive score. Second, scores can be built up from a zero baseline to provide an indication of an absolute level of risk. Both of these options are applicable to the whole range of risk scores, i.e.,: Ranking Score, Balanced Base Score, Compound Risk Score and Correlated Risk Score.

FIG. 4 is an illustration of risk scores (on Y-axis 401) presented in a Benchmark View, i.e., relative to the Benchmark Value. Each project is identified on the X-axis 402. The risk scores are illustrated in area 406. High risk Red Project 403, moderate risk Yellow Project 404 and low risk Green Project 405 are identified on the X-axis 402. The Yellow Project 404 represents the approximate point at which projects transition from more risky to less risky.

The Benchmark View emphasizes the development of risk assessment through comparisons of specific answers relative to one another. The Benchmark View is particularly powerful when examining the results of any individual question or category, as it provides the user with an immediate visual reference regarding scale. The user does not need to understand a numeric score value specific to the question because the scores are compared on a relative basis. The Benchmark View also provides a more immediate way of seeing the comparisons between the Minimum, Maximum, and Benchmark Values. However, the Benchmark View does give the impression of “passing” or “failing” the benchmark test. Depending on a user's preference, this might not be desirable (e.g., it may be seen as drawing an arbitrary bright line) or it can be a useful message encouraging projects to move towards the benchmarks set for the divisions or the corporate entity. Any type of Risk Score (e.g., Ranking Score, Balanced Base Score, Compound Score and Correlated Score) can be displayed in this manner. Alternatively, Ranking Scores and Balanced Base Scores may be displayed in a manner in which X-axis 402 represents individual questions rather than projects. Thus, the risk associated with particular questions can be evaluated.

FIG. 5 is an illustration of risk scores (on Y-axis 501) presented in a Baseline View. Each project is identified on the X-axis 502. The risk scores are illustrated in area 506. High risk Red Project 503, moderate risk Yellow Project 504 and low risk Green Project 505 are identified on the X-axis 502. The Y-axis 501 and X-axis 502 are in reverse order compared to Y-axis 401 and X-axis 402 of FIG. 4.

The Baseline View may be more relevant when using the Pareto chart to display a number of projects since the absolute position between each of the projects becomes apparent. The average risk can only be inferred as being around 100 or above or below the Yellow Project 504 and is not as readily apparent as in the Benchmark View of FIG. 4. The Baseline View provides a basis for identifying the components that make up the Risk Score, which may be based on aggregate risk of the projects on the X-axis 502. However, using the Baseline View may make it more difficult to see the comparisons between the Minimum, Maximum, and Benchmark Values. Accordingly, a user may want to see the Benchmark View of FIG. 4 as well before making any conclusions. Any type of Risk Score (e.g., Ranking Score, Balanced Base Score, Compound Score and Correlated Score) can be displayed in this manner. Alternatively, Ranking Scores and Balanced Base Scores may be displayed in manner in which X-axis 502 represents individual questions rather than projects. Thus, the risk associated with particular questions can be evaluated.

### Balanced Base Score

As described above, when computing the Ranking Scores, normalized (i.e., between 0 & 1) answers are divided by the Normalized Comparison Value (NCV). This scales the scores depending on the relative position of the Comparison Value (CV). Balanced Base Scores have the same effect, but they exaggerate the riskier answers far more than Ranking Scores. This can be achieved by raising the scores to the power

1/(1−NCV)α

This approach scales the risk scores far more, depending on the position of the CV, i.e., for scores that are higher than the CV Therefore, the normalized (between 0 and 1) answers are raised to the above power.

^{k}Balⱼⁱ=^{k}Qⱼⁱ^{^{1/(1−NCV}}^{j}^{ⁱ}^{)α}

The same can be done for the NCV (between 0 & 1), and the ratio of the two results can be calculated. Thus the Balanced Base Score is given by:

$$Balanced Base Score = \frac{{}_{}^{k}{Q}{}_{j}^{{i}^{1 / ( 1 - {NCV}_{j}^{i} ) α}}}{{NCV}_{j}^{{i}^{1 ( 1 - {NCV}_{j}^{i} ) α}}}$$

Where:

^{k}Qⱼⁱ=normalized score of the j^{th} question in the i^{th} category, for project k

NCVⱼⁱ=normalized CV of the j^{th} question in the i^{th} category

α=scalar or function; typically equal to 1

When the normalized score of the j^{th} question in the i^{th} category is equal to the NCV of the j^{th} question in the i^{th} category, then the Balanced Base Score of the j^{th} question in the i^{th} category is equal to 1. Thus, this approach ensures that at the NCV, the value result for NCV remains unchanged, i.e., it will always be 1.

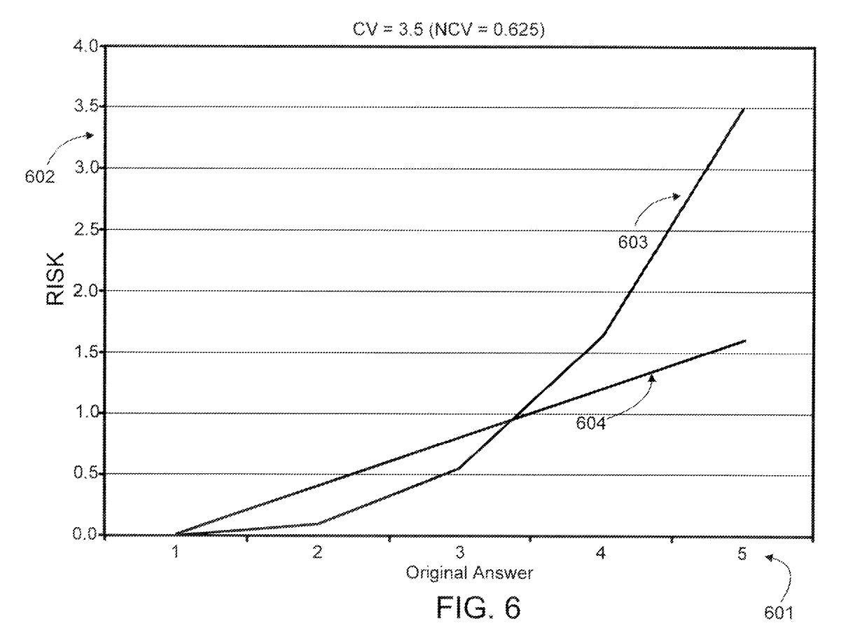

This method is more sensitive to the position of the CV than Ranking Scores. However, for very low CVs the two methods yield similar results. FIG. 6 illustrates the depicted risk (on Y-axis 602) for a range of answers (on X-axis 601). The answers range from lowest risk (1) to highest risk (6). For purposes of illustration, the CV is 3.5 and the NCV is 0.625. The risk for the range of answers is plotted as both a Ranking Score 604 and a Balanced Base Score 603. The Balanced Base Score 603 results in much smaller scores for answers that are below the CV (in this case, 3.5) and much higher scores for answers that are above the CV. Thus, this approach makes the ‘good’ (low) risks even better and the ‘bad’ (high) risks, worse. The cross-over point is the result at the CV (3.5); using either method the answer is the same at the CV. The output of FIG. 6 can be provided to a user of a risk management system and/or can be used by an analyst for internal purposes.

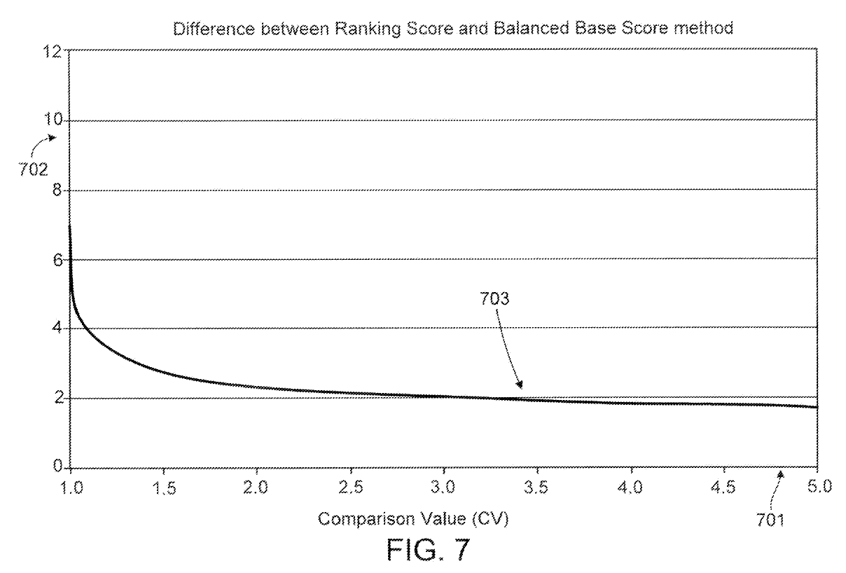

FIG. 7 illustrates the effect of the CV indicated the highest risk. For purposes of this example, the riskiest possible answer is “5.” The X-axis 701 corresponds to the CVs, whereas the Y-axis 702 corresponds to the difference between the Balanced Base Scores and the Ranking Scores. The line 703, therefore, illustrates the effect of each of these CVs (1 to 5) on the riskiest answers using both methods. Put another way, this graph illustrates the vertical distance between lines 603 and 604 of FIG. 6 at answer 5, as the CV is varied.

FIG. 7 illustrates that (1) the worst score in the Balanced Base Score method always has a higher risk value than the worst of the Ranking Score, i.e., the difference is always positive and (2) for very small CVs, the difference is much higher as compared to high CVs. This approach has an effect on risk score data. Since it exaggerates the scores of the high risk answers, most projects appear to be more risky, i.e., have higher overall risk scores.

### Compound and Correlated Risk Scores

In some implementations, Balanced Base Scores may be viewed as an intermediary step between Ranking Scores and Compound and Correlated Risk Scores to provide logic to the mathematics and give a clear presentation of comparative risk scores. It is also an intermediate step towards the calculation of an overall portfolio risk score over a group of projects.

The following is an approach for the calculation of more comprehensive risk scores, including the compound and correlation elements. In some implementations, the Balanced Base Score, the Compound Risk Score and the Correlated Risk Score link together to provide a user with a final risk score for a project, a division and/or at the corporate level.

Implementing the Compound and Correlated developments with clarity and consistency across all risk scores involves, in some implementations, the use of covariance algebra. As has been noted, this is associated with the exponential scale (e.g., the Balanced Base Score) rather than a linear scale (e.g., the Ranking Score) to prevent calculation elements being introduced and provide a consistent method of presentation. This has the effect of highlighting the riskier projects.

Compound risks are the risks within a project whereas Correlated risks are the risks between projects. Therefore, Compound Risks evaluate the cumulative effect of two different questions. For example, if two questions within a project have high risk answers, then the combined effect could produce a higher risk score as opposed to the score obtained when the two are working independently. Correlated Risks, on the other hand give the interaction of risks of all projects within the portfolio. For example, Correlated Risks relate to the change of the risk profile of a project within a portfolio, what effect that change has on risks of other projects and, hence, the overall portfolio risk.

The Compound Risk Score incorporates the correlations between questions within a project. For example, if within a project, two related questions have high risk answers, then the risk score for that project may be increased due to that relation. To calculate the Compound Risk Score, some implementations first calculate compound coefficients and compound weights.

Compound risk can also be formed of two components: enhancing risks and compensating risks. For each of these the basic concepts remain the same, however, the underlying math may differ slightly. Compound risk, therefore, can reflect both enhancing risks and compensating risks.

To calculate the compound coefficients, the similarity of answers is determined first. The similarity of answers is calculated by using the absolute difference of the Balanced Base Scores for a pair of questions, within a project. Then this difference is subtracted from 1. The subtraction is performed to ensure that the importance of similarity is oriented appropriately, i.e., questions with the same answers have the highest value (e.g., 1) and answers that are on the opposite end of the scale have least value (e.g., 0).

The next aspect in determining the compound coefficients is determining the severity of the answers. Since questions with high risk answers have a high compounding effect as compared to questions that have same answer but are at the lower end of the risk scale, the average of the Balanced Base Scores is calculated.

The calculation methodology for compounding Risk Scores also allows for the situations where two or more related risks offset one another and therefore reduce risk. These are typically called Compensating Risks.

To determine the Compound Coefficient, the similarity of the answers [a] and severity of the answers [b] are combined by taking their product ([a]*[b]). If that calculation yields a high value, it implies that not only are the answers similar in the project, but they are high risk answers as well.

However, the product of [a] and [b] is a value that has a dimension and thus, can be interpreted as the covariance of risk of the two questions. In practice, what is preferred in some implementations is a dimensionless value which will provide a better representation of correlation. In those implementations, [a]*[b] is divided by the square-root of the product of the Balanced Base Scores of the questions, i.e., the product of the variance of the individual questions. This also ensures that the compound coefficient between the same questions is always 1, as would be expected.

This yields an nXn matrix of coefficients, where each element of the matrix is given by

$${}_{}^{k}{Comp}{}_{{j}_{s}}^{{i}^{r}} = \frac{[ 1 - \vert {}_{}^{k}{Bal}{}_{j}^{i} - {}_{}^{k}{Bal}{}_{s}^{r} \vert ] * [ \frac{{}_{}^{k}{Bal}{}_{j}^{i} + {}_{}^{k}{Bal}{}_{s}^{r}}{2} ]}{\sqrt{{}_{}^{k}{Bal}{}_{j}^{i} * {}_{}^{k}{Bal}{}_{s}^{r}}}$$

### Where:

^{k}Balⱼⁱ=Balanced Base Score of the j^{th} question in the i^{th} category, for project k

^{k}Balₛ^{r}=Balanced Base Score of the s^{th} question in the r^{th} category, for project k

^{k}Compⱼ_{ₛ}ⁱ^{^{r}}=Compound coefficient between the j^{th} question in the i^{th} category and the s^{th} question in the r^{th} category, for project k

k=1, 2, . . . m

m=Number of projects

n=Number of questions in the system.

The above method is modified when applied to compensating risks. In that case, the concern is the absolute difference. Thus, in the first term, the difference between the two scores are not subtracted from 1. In the second term, the average value no longer produces a suitable coefficient. Therefore, 1 minus the first risk score times the second risk score is computed and used in the equation. (The method allows for the two scores to be interchanged and either maximums or averages to be used in the matrix depending on which question is considered to be a mitigant on the other or if they are equally important.)

If the Balanced Base Score of the j^{th} question in the i^{th} category is the same as the balanced base score of the s^{th} question in the r^{th} category, e.g., if the Compound Coefficient for the same question in the project is being calculated (i.e., diagonal elements of the matrix), then:

$${}_{}^{k}{Comp}{}_{{j}_{s}}^{{i}^{r}} = \frac{[ 1 - \vert 0 \vert ] * [ {}_{}^{k}{Bal}{}_{j}^{i} ]}{{}_{}^{k}{Bal}{}_{j}^{i}}$$

i.e., ^{k}Compⱼ_{ⱼ}ⁱ^{ⁱ}=1

i.e., the case where i=r and j=s.

It is also useful to compute a constant matrix that gives the weights or the relative importance of compounds, e.g., a matrix that gives information as to which pair of questions produce a compounding effect and to what extent (i.e., Compound Weight). For example, if question Q is coupled with questions X, Y and/or Z, and compound effect is important, there will be a high Compound Weight for these questions. But, for example, if Q is coupled with questions M and/or N which do not have a compounding relationship with Q, then the result impacts the risk assessment less significantly and therefore, will have zero Compound Weight. Therefore, if two questions have high a Compound Weight, then this implies that these two questions occurring together produce a higher risk score than either question alone.

Determination of actual weights can be derived in a range of processes that examine the relative importance with respect to the relationship between two questions and answers. This can be statistical, Bayesian or through discussion and expert review of factors such as their relative combined impact, overall volatility, controllability and mitigating impacts. Question, Category and Project scores can be used within a Bayesian network to interpret the causal relationships between variables and hence the likelihood of correlations either positive or negative.

In the case of Compensating Risks, the weights are negative and thus reduce the overall risk score.

For example, assume that Z is an nXn constant matrix that gives the weights or relative importance of compounds and:

Zⱼ_{ₛ}ⁱ^{^{r}}=Compound weight of the j^{th} question in the i^{th} category and the s^{th} question in the r^{th} category

n=Number of questions in the system

A second constant nXn matrix (W) for each question is given by

Wⱼ_{ₛ}ⁱ^{^{r}}=√; \sqrt{[Wⱼⁱ*Wₛ^{r}]}

Where

Wⱼⁱ=Weight of the j^{th} question in the i^{th} category

Wₛ^{r}=Weight of the s^{th} question in the r^{th} category.

In some implementations, however, each Wⁱⱼ will be divided by the corresponding 10 Balanced NCV. This step can be used to bring the NCV into the calculations. Also, this step can be introduced for computational ease and quicker calculations and to demonstrate the difference in the weights used in the compound and correlation section, discussed below. Thus, such implementations would have another matrix, W′ where each element of the matrix will be:

$${W}_{{j}_{s}}^{′ {i}^{r}} = \sqrt{[ \frac{{W}_{j}^{i}}{{}_{}^{b}{NCV}{}_{j}^{i}} * \frac{{W}_{s}^{r}}{{}_{}^{b}{NCV}{}_{s}^{r}} ]}$$

Where

^{b}NCVⱼⁱ=Balanced NCV of the j^{th} question in the i^{th} category=NCVⱼⁱ^{^{[1/{1−NCV}}^{j}^{^{i}]}}

^{b}NCVₛ^{r}=Balanced NCV of the s^{th} question in the r^{th} category=NCVₛ^{r}^{^{[1/{1−NCV}}^{s}^{^{r}]}}

i=1, 2, . . . 9

α=1

When i=r and j=s, i.e., diagonal elements, then

$${W}_{{j}_{j}}^{′ {i}^{i}} = \frac{{W}_{j}^{i}}{{}_{}^{b}{NCV}{}_{j}^{i}}$$

In this example, “i” goes up to 9, but in general, it could go up to any value.

Multiplying the above matrices Z and W (which is mathematically possible as all of the matrices are nXn, i.e., all questions in the system across the rows and columns), results in another nXn matrix.

There are, e.g., two methods of allocating compound weights to the matrix. Without compounding, all weights are allocated to the diagonal of the matrix, thus in effect allocated to the individual questions within each category.

Weights may either be:

1) Re-allocated across compounded and non-compounded answers across all cells in the matrix thus giving the same total of all weights as before compounding (typically 100%);

or

2) Allocate weights in the non diagonal cells in addition to the weights allocated to the diagonal cells of the matrix of non-compounded question results. In this case the total of all weights will increase (and hence the sum of the diagonal cells will equal 100% and hence the sum of all cells will exceed 100% in the typical case).

Method (1) will, in general, reduce the risk scores of most projects. Projects with compound risks will have higher risk scores than before compared to those with few or no compound risks.

Method (2) will increase the risk score for all projects with any compound element. Those with no compound element will have the same score before and after application of the weights for compound risks.

The relative difference between non-compound and compounded risk scores for any project will remain the same whichever method is chosen.

This resulting matrix is then multiplied by the (nX1) matrix of Balanced Base Scores of all questions for the project (i.e., a matrix with dimensions of n by 1, often written as (n,1)). Therefore, each element of this resulting nX1 matrix will be

$${}_{}^{k}{CompScore}{}_{j}^{i} = \sqrt{( {}_{}^{k}{Bal}{}_{j}^{i} )} * {\sum }_{rs} [ ( {}_{}^{k}{Bal}{}_{s}^{r} ) * {}_{}^{k}{Comp}{}_{{j}_{s}}^{{i}^{r}} * {W}_{{j}_{s}}^{′ {i}^{r}} * {Z}_{{j}_{s}}^{{i}^{r}} ]$$

The symbols have the same meanings as in earlier formulae and the summation is performed over all questions s=1, 2, . . . and r=1, 2, . . .

The Compound Score for the project k, i.e., the risk score taking into account compounds between questions will be given by

$$Compound {Score}^{k} = {\sum }_{ij} {}_{}^{k}{CompScore}{}_{j}^{i}$$

Where the summation runs over all j=1, 2, . . . n and i=1, 2, . . . n.

The diagonal elements of this matrix will be given by

$${}_{}^{k}{CompScore}{}_{j}^{i} = \sqrt{( {}_{}^{k}{Bal}{}_{j}^{i} )} * {\sum }_{ij} [ \sqrt{( {}_{}^{k}{Bal}{}_{j}^{i} )} * 1 * \frac{{W}_{j}^{i}}{{}_{}^{b}{NCV}{}_{j}^{i}} * {Z}_{{j}_{j}}^{{i}^{i}} ] = {}_{}^{k}{Bal}{}_{j}^{i} * {W}_{j}^{i} * \frac{{Z}_{{j}_{j}}^{{i}^{i}}}{{}_{}^{b}{NCV}{}_{j}^{i}}$$

Also, in the absence of compounds, i.e., when Zⱼ_{ₛ}ⁱ^{^{r}}=0 for all i≠r and j≠s,

$$Compound {Score}^{k} = {\sum }_{ij} {}_{}^{k}{Bal}{}_{j}^{i} * \frac{{W}_{j}^{i}}{{}_{}^{b}{NCV}{}_{j}^{i}}$$

i.e., the Balanced Base Score.

The final step in some implementations is to evaluate the correlated score, i.e., the final risk score that incorporates the compound and correlation elements. This step computes the correlations between projects, e.g., if one project has a high risk score and another also has a high risk score, then it is expected that the overall risk for both will be higher if there are correlations.

In some implementations, the method of computing the correlation coefficients is the same in the correlation section as it was in the compound section. As before, this also comprises three elements: similarity of risk scores, severity of risk scores and the variance in order to make it a dimensionless quantity. The only major difference is that in compounds, each of these elements for each pair of questions within a project is computed; in correlation, these elements are computed for a particular question or category between a pair of projects.

Where projects are considered to provide compensating risk (for example two projects that can provide spare capacity for each other) then similar adjustments are made to the formulae as are applied to compound risk scores in respect for compensating risks within individual projects.

Each element of the mXm matrix, where m=number of projects, is given by

$${}_{}^{kl}{Correl}{}_{j}^{i} = \frac{[ 1 - \vert {}_{}^{k}{Bal}{}_{j}^{i} - {}_{}^{1}{Bal}{}_{j}^{i} \vert ] * [ \frac{{}_{}^{k}{Bal}{}_{j}^{i} + {}_{}^{1}{Bal}{}_{j}^{i}}{2} ]}{\sqrt{[ {}_{}^{k}{Bal}{}_{j}^{i} * {}_{}^{1}{Bal}{}_{j}^{i} ]}}$$

where k and l are the pair of projects in question, and all other symbols have the same meanings as in prior formulae. The diagonal elements of this matrix, e.g., when the coefficients for the same project are being computed, will be equal to one (1):

^{k}^{^{k}}Correlⱼⁱ=1.

As with the matrix of Compound Weights discussed above, some implementations utilize another vector of weights that indicates the importance of correlations in questions. Therefore, there may be questions or categories that have a high correlated impact and some that have minimal, no, or negative (risk reducing) correlated impact. For example, two projects based in the same country may have high correlated impact whereas two projects that have the same project manager may have minimal or no correlated impact.

Such an nX1 vector can be represented by Y wherein each element is given by

Yⱼⁱ=correlation weight for question j in the i^{th} category.

In the calculation of the Correlated Score, some implementations incorporate the relative size of each project, e.g., how much does each project contribute to the overall size or investment of the portfolio.

An mX1 vector of such weights or sizes can be represented by S wherein each element is given by

^{k}S=the proportionate contribution or the size of the k^{th} project

The matrix S of relative project size could be computed using the gross margin or revenue proportions of a project relative to the division or corporate, as appropriate.

In the compound risk section, the Balanced Base Score arrays are used to compute the Compound Score However, to arrive at a Final Correlated Score, instead of using the Balanced Base score, the compound score for each question within each category is used to compute the correlated score, e.g.:

$${}_{}^{k}{CorrelScore}{}_{j}^{i} = {}^{k} S * \sqrt{( {}_{}^{k}{CompScore}{}_{j}^{i} )} * {\sum }_{l} ⌊ \sqrt{( {}_{}^{1}{CompScore}{}_{j}^{i} )} * {}^{1} S * {}_{}^{k 1}{Correl}{}_{j}^{i} ⌋$$

where the summation is over all of the projects.

Therefore,

$$Correlated {Score}^{k} = Compound {Score}^{k} + {\sum }_{ij} [ {}_{}^{k}{CorrelScore}{}_{j}^{i} * {Y}_{j}^{i} ]$$

where the summation runs over all of the questions j=1, 2, . . . n (i=1, 2, . . . n). In the absence of any correlated weights, e.g., when Yⁱⱼ=0, then Correlated Score^{k}=Compound Score^{k}.

Thus, the diagonals will be

^{k}CorrelScoreⱼⁱ=^{k} CompScoreⱼⁱ

and

$$Correlated {Score}^{k} = {\sum }_{ij} {}_{}^{k}{CompScore}{}_{j}^{i} = Compound {Score}^{k} .$$

### Portfolio Risk Score

A value of interest in some implementations is the overall riskiness of the portfolio, e.g., how does the overall risk of the portfolio change if a new project is added to the portfolio. In order to determine this, one option is to calculate the portfolio variance risk score.

Once the Correlated Risk Score for each project has been determined (i.e., the compounding effect of questions within a project, correlated effect of other projects in the portfolio and the relative size of each project have all been accounted for), the next step would be to calculate the portfolio variance. To do this, all of the Correlated Risk Scores across the portfolio are added and the square root is taken.

Therefore,

$$Portfolio Variance = \sqrt{[ {\sum }_{k} Correlated {Score}^{k} ]} .$$

### Implementations of a Risk Management System

Various implementations of systems are possible for applying the foregoing computational and analytical approaches (in whole or in part) and generating, as output data, a risk analysis for a user. For example, some implementations allow a user to fill out a form (e.g., on paper) with answers to questions that pertain to the risk of a particular project, and provide the form to an analyst who performs the analysis (e.g., using a computer). The analyst can then provide the results of the analysis to the user. In other implementations, the user can interface with an electronic terminal (e.g., a PC or a kiosk).

The data that the user provides to the electronic terminal is transmitted for processing, and the results of the analysis are displayed on the electronic terminal. The user may have the option of obtaining a hard copy of the analysis.

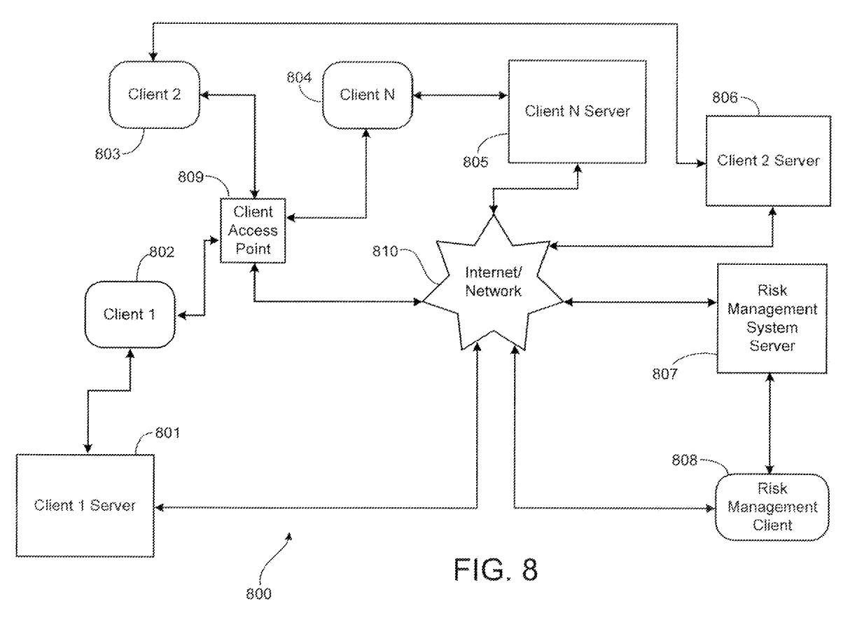

FIG. 8 is an implementation of a system 800 for applying the foregoing computational and analytical approaches (in whole or in part) and generating, as output data, a risk analysis for a user. Users who request a risk analysis interface with client electronic terminals 802, 803 and 804 (e.g., PCs, kiosks, PDAs, cellular phones, and/or wireless email devices). Client N 804 represents that there can be any “N” number of client electronic terminals. Each client may be associated with its own respective server 801, 806 and 805. For example, client 802 may be an electronic terminal within a corporation. The corporation may have its own internal network that is associated with server 801 and client 802. In some networks, individual terminals (e.g., 802) do not store certain corporate information such as accounting data. Thus, during the risk analysis procedure, certain data can be retrieved from the server 801. For example, a question during the risk analysis procedure may be directed to the gross margin for a particular project. The client terminal 802 can access the accounting data (e.g., in a data store) on server 801 and automatically retrieve the relevant data.

The various terminals and servers may be connected together by various private and public networks. For example, terminal 802 and server 801 may be connected by a private network that provides secure data exchange within the corporation. However, both the terminal 802 and server 801 may also be connected to a larger (e.g. public) network 810 such as the Internet. The clients 802, 803 and 804 may access the network 810 via an access point 809. The access point may take the form, e.g., of a server, a wireless access point, or a hub.

The Risk Management System Server 807 (“RMSS”), in some implementations, performs the majority of the processing associated with the computational and analytical approaches. The RMSS 807 is coupled to the network 810 so that terminals 802, 803 and 804 can interface with the RMSS 807. A Risk Management Client 808 is connected to the RMSS 807 (e.g., by a private network) as well as to the network 810. The client terminals access an Internet website, for example, that is hosted on or associated with the RMSS 807. Once on the website, users (e.g., via the terminals 802, 803 and/or 804) interface with the RMSS 807. Interfacing may include developing questions relating to certain projects, answering questions (see, e.g., FIG. 11), and receiving output data relating to risk management. The RMSS 807 uses data provided by the users, applies some or all of the foregoing computational and analytical approaches, and generates the risk management output data. The Risk Management Client 808 can be, for example, operated by an analyst who can provide real time assistance or guidance to a user of a client terminal (e.g., 802-804.

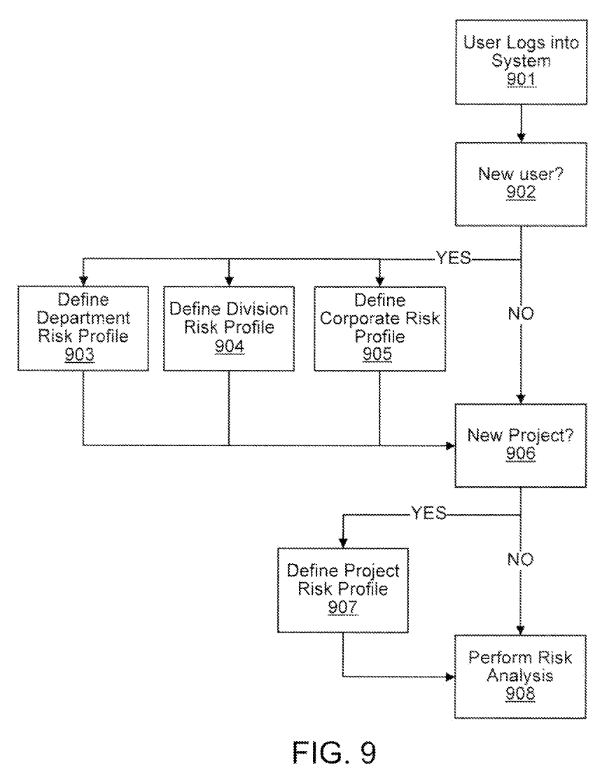

FIG. 9 illustrates an implementation of a method for interfacing with a risk analysis system (e.g., by an entity operating one of client terminals 802, 803 or 804 of FIG. 8 and interfacing with the RMSS 807). The user first logs into the system (901). Depending upon the implementation, this may take the form of a user pointing a web browser to a certain URL. The web browser will display certain content, including a log in prompt. The user may be required to provide a user name and a password. This data may be provided by the party operating the risk analysis system, or a user may define his own user name and/or password. Some implementations may require a user to enter an activation code or the like (provided by or on behalf of the party operating the risk analysis system) that is entered on the user's first log in.

After the user logs in, the system determines whether the user is a new user (902). If the user is new, then the system collects information about the user's department 903, division 904 and corporation 905. The information collected may include general information (e.g., number of employees, payroll, gross margins, sector, and/or growth) but also includes, in some implementations, information particularly directed to risk and risk tolerance. For example, as part of the corporate risk management plan, a certain department may be allowed to tolerate more or less risk. Thus, an example of information gathered at block 903 may include: (1) whether the division in question is working on products/services in a competitive market; (2) whether the labor pool for that division is inadequate or diluted and/or (3) how much revenue the corporation obtains from that department. These factors may all affect the risk tolerance of that department. Accordingly, block 903 can set a risk threshold for a particular department that is used in subsequent analysis (e.g., the “scoring” procedures discussed above).

Also, as part of the corporate risk management plan, certain divisions may be allowed to tolerate more or less risk. Examples of information gathered at block 904 may include: (1) whether the division deals in products/services that are in competitive market(s); (2) characteristics of the labor pool; (3) to what degree the corporation derives its revenue from this division and/or (4) the risk profile of other projects in the division. All these factors may affect the risk tolerance of that division. Accordingly, block 904 can set a risk threshold for a particular division that is used in subsequent analysis (e.g., the “scoring” procedures discussed above).

The corporation itself may set an overall risk tolerance. Examples of information gathered at block 905 may include: (1) whether the corporation deals in products/services that are in competitive market(s); (2) characteristics of the labor pool; (3) the extent to which the corporation is profitable and/or (4) the risk profile of other projects in the corporation. These factors may all affect the risk tolerance of the corporation. Accordingly, block 905 can set a risk threshold for a corporation that is used in subsequent analysis (e.g., the “scoring” procedures discussed above).

Blocks 903, 904 and/or 905 can be repeated as the user desires. For example, these blocks may be repeated if there are changes in the department, division or corporation that may affect the risk calculation.

Next, the system determines if the project for which the user requests analysis is a new project (906). If so, the project risk profile is defined (907). This includes development of questions, answers and benchmarks that relate to the risk of the project.

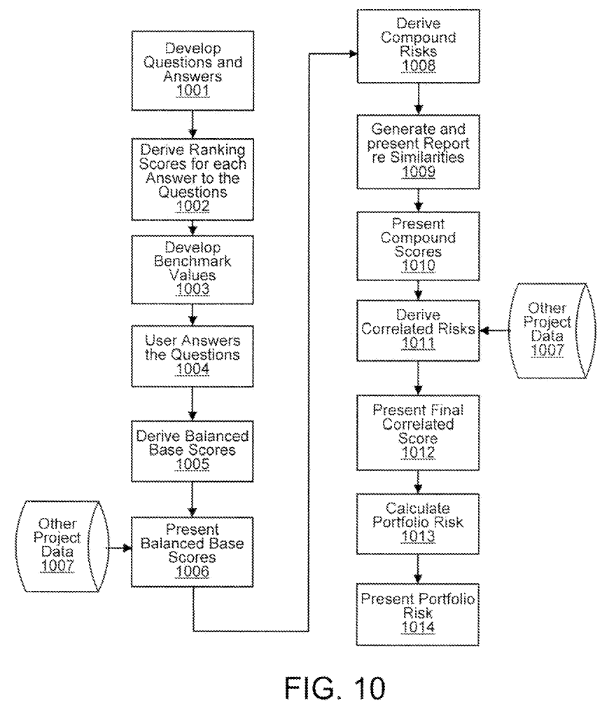

This is discussed in some detail in connection with, e.g., Ranking Scores and Balanced Base Scores, and is also discussed in connection with FIGS. 10-13. Examples of information gathered at block 907 (e.g., in response to questions) may include: (1) the budget associated with the project; (2) the total budget allocated to the department in which the project resides; (3) the identity of the project leader and/or participants; (4) prior failures in related projects; (5) the existence of legal or regulatory challenges and/or (6) price fluctuations in raw goods. The user's answers are scored, and the risk analysis is performed (908).

FIG. 10 illustrates some details of the risk analysis method (including, e.g., aspects of blocks 907 and 908 of FIG. 9). This implementation of the method and the analysis of the example projects employ the computational approach discussed in the section entitled “Computational and Analytical Overview.”

Initially, for a given project, questions and answers are developed (1001) that relate to the project's risk. The questions and answers, in some implementations, are developed solely by the user. In other implementations, the questions and answers are developed in conjunction with an analyst or representative of the entity who operates the risk management system. It is more likely that the analysis will provide an accurate assessment of risk if questions are developed that relate to the risk of a given project. Generally speaking, the more relevant questions that are developed, the more accurate the risk assessment will be. Irrelevant questions may complicate the analysis without adding meaningful data. It is also a concern that relevant, reasonable answers are identified for each question. For the compound and correlated risk analyses, for example, data is developed that identifies whether the risks associated with particular questions, categories, and/or projects have compound and/or correlating effects.

In one example, the client may be in the business of owning, operating and providing satellite services. Questions that are developed (e.g., at block 1001) may relate to several categories of risk, for example, (1) satellite technical performance, (2) customer base; (3) competitors/marketplace; (4) geo-political and (5) financial. For purposes of this example, each satellite is treated as a separate “project.” Some examples of questions and answers for each project are provided in the screen shot of FIG. 11, which represents an example of an interface with which a user would interact in a risk assessment system.

In the example questions of FIG. 11, the answers are ordered from lowest risk (“A” answers) to highest risk (“E” answers). Additional questions may relate to topics such as the satellite manufacturer, the year of manufacture, specialty of satellite (e.g., single or multiphase), types of customer, political risks and financial structure of satellite ownership. The computation may assign a numeric value to each answer. In this example, the answers will be assigned the following values:

| Answer | Value |
|---|---|
| A | 1 |
| B | 2 |
| C | 3 |
| D | 4 |
| E | 5 |

Next, Ranking Scores are developed for each answer to each question (1002). This process is discussed in some detail in connection with the Ranking Scores and Balanced Base Scores. This process involves assigning a score for each answer to each question and setting a “norm” score for each question (e.g., a “CV” as discussed above). Then, the Ranking Score can be determined for each answer. The Ranking Score may be calculated by dividing the normalized answer by the normalized CV. The CV may be developed by the user, or in conjunction with, e.g., an analyst or representative of the entity who operates the risk management system. In some implementations, the system may suggest a CV based on the question and/or range of answers.

Optionally, a Benchmark Value is developed (1003). As discussed above, the Benchmark Value provides a reference point for evaluating the risks of different projects (as opposed to individual questions). The Benchmark Value may be analogized to a CV, but for projects rather than questions. The Benchmark Value thus represents a baseline risk for projects in general. The Benchmark Value may be developed by the user, or in conjunction with, e.g., an analyst or representative of the entity who operates the risk management system. In some implementations, the system may suggest a Benchmark Value based on, for example, data gathered at blocks 903, 904 and/or 905 of FIG. 9.

Then, the user answers the questions (1004). This may be done at any point after the questions and answers have been developed. For example, a user may develop the questions and answers in one session, and then log into the system at some later point to answer the questions. With respect to the screen shot of FIG. 11, the user may answer questions by using a mouse to “click” the appropriate answer (e.g., A, B, C, D or E).

Based on the answers to the questions, the Balanced Base Scores are derived (1005). This is largely a computational process performed by the system. As discussed, the Balanced Base Scores tend to emphasize higher risk answers and, consequently, higher risk projects. The Balanced Base scores are then presented to the user (1006). The scores may be presented on a per question basis, e.g., to allow the user to identify high-risk aspects of a single project, or compare projects on a project-by-project basis. When presenting the Balanced Base Scores on a project basis, data regarding other projects may be retrieved from a data store 1007. This data can be presented in several ways. Examples include displaying the Balanced Base Scores relative to Benchmark Values (see, e.g., FIG. 4 as an example of a screen shot) or a baseline view (see, e.g., FIG. 5 as an example of a screen shot). The Balanced Base Scores, though an “intermediate” result in some implementations, provide some insight into the risk of a project relative to other projects.

The following table illustrates the calculation of, among other things, the NCV, Ranking Score and Balanced Base Score of each possible answer for Questions 1-3 of the satellite company example. Depending on the implementation, this data may be presented to the user. For Question 1, a CV of 3 was established, for Question 2 a CV of 2 was established and for Question 3 a CV of 2.5 was established. Moreover, this table illustrates that each question may be assigned a weight. The weight relates to the overall importance of the question in the risk assessment process. The total weights of all questions adds to 100% in some implementations. The weight is also presented as a Raking Score and Balanced Base score, but these figures may be used for calculation purposes and not presented to the user. The user, analyst, or system may, in some implementations, provide the question weights in terms of percentages.

The rightmost column illustrates the normalized risk score, Ranking Score and Balanced Base Score at the CV value. Therefore, for Question 1, this column is identical to the column for answer “C” and for Question 2, this column is identical to the column for answer “B”. In Question 3, the CV is 2.5, and as such, this column is unique compared to the answer columns.

Question 1

| | CV | NCV | NCV^{(1/(1-NCV)} | | | | |
|---|---|---|---|---|---|---|---|
| | 3 | 0.5 | 0.25 | | | Weight | |
| Answer | A | B | C | D | E | 45% | At CV |
| Value | 1 | 2 | 3 | 4 | 5 | | 3 |
| Normal- | 0 | 0.25 | 0.50 | 0.75 | 1.00 | | 0.50 |
| ized | | | | | | | |
| Risk Score | | | | | | | |
| Ranking | 0 | 0.50 | 1.00 | 1.50 | 2.00 | 0.90 | 1.00 |
| Score | | | | | | | |
| Balanced | 0 | 0.25 | 1.00 | 2.25 | 4.00 | 1.80 | 1.00 |
| Base | | | | | | | |
| Score | | | | | | | |

Question 2

| | CV | NCV | NCV^{(1/(1-NCV)} | | | | |
|---|---|---|---|---|---|---|---|
| | 2 | 0.25 | 0.16 | | | Weight | At |
| Answer | A | B | C | D | E | 30% | CV |
| Value | 1 | 2 | 3 | 4 | 5 | | 2 |
| Normal- | 0 | 0.25 | 0.50 | 0.75 | 1.00 | | 0.25 |
| ized | | | | | | | |
| Risk Score | | | | | | | |
| Ranking | 0 | 1.00 | 2.00 | 3.00 | 4.00 | 1.20 | 1.00 |
| Score | | | | | | | |
| Balanced | 0 | 1.00 | 2.52 | 4.33 | 6.35 | 1.90 | 1.00 |
| Base | | | | | | | |
| Score | | | | | | | |

Question 3

| | CV | NCV | NCV^{(1/(1-NCV)} | | | | |
|---|---|---|---|---|---|---|---|
| | 2.5 | 0.38 | 0.21 | | | Weight | At |
| Answer | A | B | C | D | E | 25% | CV |
| Value | 1 | 2 | 3 | 4 | 5 | | 2.5 |
| Normal- | 0 | 0.25 | 0.50 | 0.75 | 1.00 | | 0.38 |
| ized | | | | | | | |
| Risk Score | | | | | | | |
| Ranking | 0 | 0.67 | 1.33 | 2.00 | 2.67 | 0.67 | 1.00 |
| Score | | | | | | | |
| Balanced | 0 | 0.52 | 1.58 | 3.03 | 4.80 | 1.20 | 1.00 |
| Base | | | | | | | |
| Score | | | | | | | |

Next, Compound Risk Scores are derived (1008). These scores are the evaluation of the cumulative effect of different risks within a single project. These scores are derived largely by a computation process performed by the system. Based on the Compound Risk Scores, a report is generated and presented regarding certain similarities (1009). This report helps the user to identify risks in a project that are interacting in a manner that increases overall risk more than either risk alone. A high positive coefficient implies that answers are similar, both have high risk answers and that the two questions together increase the overall risk of the portfolio. This report may assist a user in changing one or two parameters in a project, resulting in a much lower overall risk.

In the satellite company example discussed above, competitors' spare capacity and length of contract terms may represent compound risks. A lot of competitor spare capacity combined with short contractual terms is likely to make the revenue more volatile. The existence of compounding effects may be provided in the form of a matrix, i.e., to what extent each question affects the risk associated with another question. This matrix may be provided by the client, an analyst, or identified by the system. In this example, the compound matrix is as follows (positive numbers imply risk enhancing questions, and negative numbers imply risk reducing questions):

| | Question 1 | Question 2 | Question 3 |
|---|---|---|---|
| Question 1 | 0.45 | 0.40 | −0.30 |
| Question 2 | 0.40 | 0.30 | 0.35 |
| Question 3 | −0.30 | 0.35 | 0.25 |

It is also relevant to quantify not only the existence of compounding effects, but also their importance. Thus, a weights matrix is created that represents the relative importance of compounds, i.e., if questions have a compounding effect, the extent of that effect. This matrix is based on the relative weights of the questions, and is calculated by the system. First, the balanced weight for each question is calculated as follows:

$$Balanced Weights = \frac{Question Weight}{{NVC}^{( 1 / ( 1 - NCV )}}$$

Then, the weights matrix for each question is calculated as follows:

$$Weights Matrix = \sqrt{( Balanced {Weight}_{1} * Balanced {Weight}_{2} )}$$

In the satellite company example, the weights matrix is as follows:

| | Question 1 | Question 2 | Question 3 |
|---|---|---|---|
| Question 1 | 1.80 | 1.85 | 1.47 |
| Question 2 | 1.85 | 1.90 | 1.51 |
| Question 3 | 1.47 | 1.51 | 1.20 |

In this example, the satellite company has a portfolio of several projects (wherein each “project” refers to an individual satellite). For purposes of illustration, the portfolio consists of six projects, and for each, the user answered the three example questions as follows (“Original answer”) and the system calculated the following values (“Rebalanced answers” and “Balanced Base Scores”):

| | Green | Red | LowRisk | MedRisk | HighRisk | CVPrj | |
|---|---|---|---|---|---|---|---|
| | Project | Project | Project | Project | Project | Project | |
| Question 1 | 2 | 5 | 2 | 3 | 4 | 3 | Original answer |
| Question 2 | 2 | 5 | 2 | 3 | 4 | 2 | |
| Question 3 | 2 | 4 | 3 | 4 | 5 | 2.5 | |
| Question 1 | 0.25 | 1.00 | 0.25 | 0.50 | 0.75 | 0.50 | Rebalanced |
| Question 2 | 0.25 | 1.00 | 0.25 | 0.50 | 0.75 | 0.25 | answers |
| Question 3 | 0.25 | 0.75 | 0.50 | 0.75 | 1.00 | 0.38 | |
| Question 1 | 0.06 | 1.00 | 0.06 | 0.25 | 0.56 | 0.25 | Balanced Base |
| Question 2 | 0.16 | 1.00 | 0.16 | 0.40 | 0.68 | 0.16 | Scores |
| Question 3 | 0.11 | 0.63 | 0.33 | 0.63 | 1.00 | 0.21 | |

The descriptions of the projects are as follows:

| | |
|---|---|
| Green | An indicator project (e.g., set by management) representing |
| | the lower boundary risk |
| Red | An indicator project (e.g., set by management) representing |
| | the upper boundary risk |
| LowRisk | A low risk project |
| MedRisk | A medium risk project, with few risky and few less risky |
| | elements |
| HighRisk | A high risk project |
| CVPrj | Project where answer to every question is equivalent to the |
| | CV of that question. The risk score for this project is equal |
| | to 1 |

In this example, the compound weights are rescaled to ensure that the rows always sum to 100%. The Compound Coefficients for these projects are calculated and represented by the following matrices:

Red Project Compound Coefficients

| | Question 1 | Question 2 | Question 3 |
|---|---|---|---|
| Question 1 | 1.00 | 1.00 | 0.09 |
| Question 2 | 1.00 | 1.00 | 0.65 |
| Question 3 | 0.09 | 0.65 | 1.00 |

Green Project Compound Coefficients

| | Question 1 | Question 2 | Question 3 |
|---|---|---|---|
| Question 1 | 1.00 | 1.00 | 0.51 |
| Question 2 | 1.00 | 1.00 | 0.97 |
| Question 3 | 0.51 | 0.97 | 1.00 |

LowRisk Project Compound Coefficients

| | Question 1 | Question 2 | Question 3 |
|---|---|---|---|
| Question 1 | 1.00 | 1.00 | 1.50 |
| Question 2 | 1.00 | 1.00 | 0.88 |
| Question 3 | 1.50 | 0.88 | 1.00 |

MedRisk Project Compound Coefficients

| | Question 1 | Question 2 | Question 3 |
|---|---|---|---|
| Question 1 | 1.00 | 0.88 | 0.54 |
| Question 2 | 0.88 | 1.00 | 0.79 |
| Question 3 | 0.54 | 0.79 | 1.00 |

HighRisk Project Compound Coefficients

| | Question 1 | Question 2 | Question 3 |
|---|---|---|---|
| Question 1 | 1.00 | 0.89 | 0.13 |
| Question 2 | 0.89 | 1.00 | 0.69 |
| Question 3 | 0.13 | 0.69 | 1.00 |

CVPrj Project Compound Coefficients

| | Question 1 | Question 2 | Question 3 |
|---|---|---|---|
| Question 1 | 1.00 | 0.93 | 0.14 |
| Question 2 | 0.93 | 1.00 | 0.96 |
| Question 3 | 0.14 | 0.96 | 1.00 |

Based on the compound coefficients, the Compound Risk Scores for each question and overall project are calculated. The results are represented by the following matrices:

Red Project Compound Risk Scores

| | | | |
|---|---|---|---|
| Question 1 | Question 2 | Question 3 | Sum |

| | | | | |
|---|---|---|---|---|
| Question 1 | 1.62 | 0.74 | −0.03 | 2.33 |
| Question 2 | 0.74 | 0.48 | 0.27 | 1.49 |
| Question 3 | −0.03 | 0.27 | 0.72 | 0.96 |

| | |
|---|---|
| Red Project | 4.78 |
| Compound | |
| Risk Score | |

Green Project Compound Risk Scores

| | Question 1 | Question 2 | Question 3 | Sum |
|---|---|---|---|---|
| Question 1 | 0.10 | 0.07 | −0.02 | 0.16 |
| Question 2 | 0.07 | 0.08 | 0.07 | 0.22 |
| Question 3 | −0.02 | 0.07 | 0.12 | 0.17 |

| | |
|---|---|
| Green Project | 0.54 |
| Compound Risk | |
| Score | |

LowRisk Project Compound Risk Scores

| | Question 1 | Question 2 | Question 3 | Sum |
|---|---|---|---|---|
| Question 1 | 0.10 | 0.07 | −0.09 | 0.08 |
| Question 2 | 0.07 | 0.08 | 0.11 | 0.26 |
| Question 3 | −0.09 | 0.11 | 0.38 | 0.39 |

| | |
|---|---|
| LowRisk | 0.72 |
| Project | |
| Compound Risk | |
| Score | |

MedRisk Project Compound Risk Scores

| | Question 1 | Question 2 | Question 3 | Sum |
|---|---|---|---|---|
| Question 1 | 0.41 | 0.20 | −0.09 | 0.52 |
| Question 2 | 0.20 | 0.19 | 0.21 | 0.60 |
| Question 3 | −0.09 | 0.21 | 0.72 | 0.83 |

| | |
|---|---|
| MedRisk | 1.95 |
| Project | |
| Compound Risk | |
| Score | |

HighRisk Project Compound Risk Scores

| | Question 1 | Question 2 | Question 3 | Sum |
|---|---|---|---|---|
| Question 1 | 0.91 | 0.41 | −0.04 | 1.27 |
| Question 2 | 0.41 | 0.32 | 0.30 | 1.03 |
| Question 3 | −0.04 | 0.30 | 1.14 | 1.40 |

| | |
|---|---|
| HighRisk | 3.71 |
| Project | |
| Compound Risk | |
| Score | |

CVProj Project Compound Risk Scoores

| | Question 1 | Question 2 | Question 3 | Sum |
|---|---|---|---|---|
| Question 1 | 0.41 | 0.14 | −0.01 | 0.53 |
| Question 2 | 0.14 | 0.08 | 0.09 | 0.30 |
| Question 3 | −0.01 | 0.09 | 0.24 | 0.32 |

| | |
|---|---|
| CVProj Project | 1.15 |
| Compound Risk | |
| Score | |

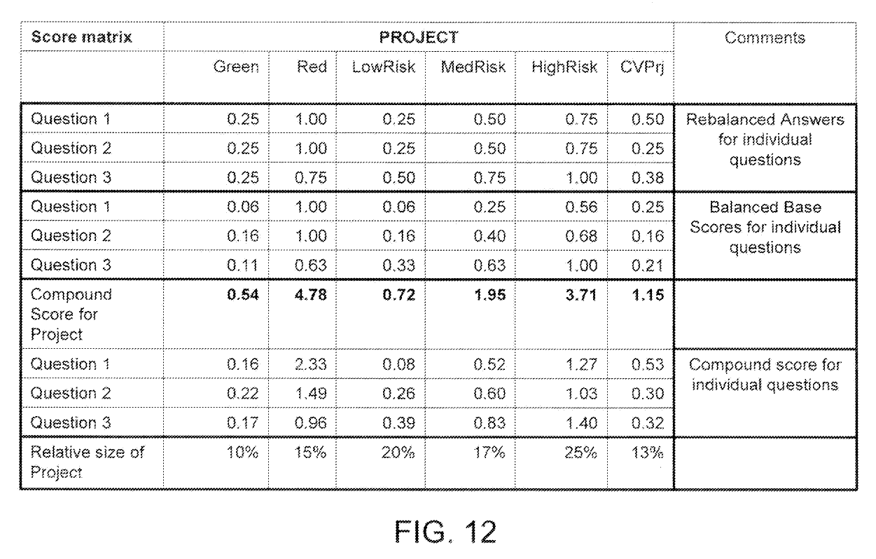

The Compound Scores are then presented to the user (1010). They can be presented across projects in a manner similar to the Balanced Base Scores (see, e.g., FIGS. 4 and 5 as examples of how Compound Scores may be presented to a user), or the number for one project can be provided. Also, a user can view the results on a per-question basis or the data from these calculations may be presented to the user in the matrices as shown. Alternatively, some implementations may provide the user with a summary Score Matrix that provides certain of this data in a summary form. An example screen shot of a Score Matrix is illustrated in FIG. 12.

Next, the system derives Correlated Risk Scores (1011). These scores reflect the interaction of risks of all projects within a portfolio (which a user may define in, e.g., blocks 903, 904, 905 and/or 907 of FIG. 9). Thus, the Correlated Risk Scores assist a user in evaluating to what extent, if any, the risk profile of a project changes based on changes in the risks of another project within the same portfolio. These scores are derived largely by a computation process performed by the system. To arrive at this information, other project data is retrieved from a data store 1007 (e.g., if the user is currently analyzing the Red Project, data regarding the HighRisk Project or LowRisk Project may be retrieved from the data store 1007).

In the satellite company example discussed above, where the manufacturer and approximate age of the satellite are the same that may represent a correlated risk. These two factors could increase the potential for multiple failures from the same technical cause.

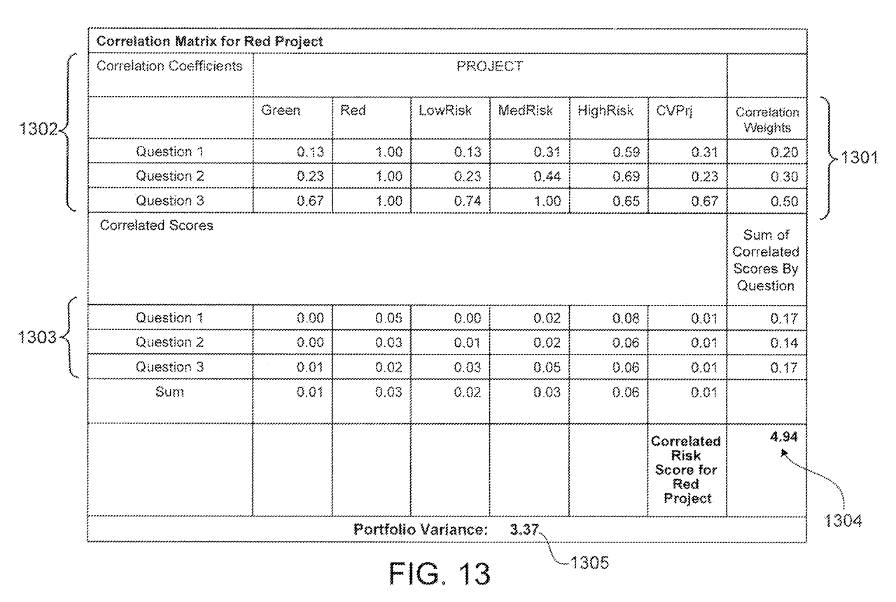

The Correlated Risk Scores are then presented to the user (1012). They can be presented across projects in a manner similar to the Balanced Base Scores (see, e.g., FIGS. 4 and 5), or the number for one project can be provided. The Correlated Risk Scores for the Red Project, for example, may be provided in a Correlated Risk Scores Matrix of FIG. 13. FIG. 13 illustrates the Correlation Weights 1301, which represent the importance of correlations in questions across projects. These weights may be provided by the user, an analyst, or derived by the system. The Correlation Coefficients (discussed above) are provided at 1302. The Correlated Scores for each question are provided at 1303. These values represent the impact of questions in other projects upon the corresponding question in the Red Project. The Correlated Risk Score for the Red Project is provided at 1304.

Turning back to FIG. 10, the Portfolio Risk Score (or “Portfolio Variance”) is calculated (1013). This value represents the overall riskiness of a portfolio and helps a user to determine to what extent, if any, the overall risk of the portfolio will change if a new project is added. This value is largely a computation process performed by the system. The result of the calculation is presented to the user (1014). For example, the Correlated Risk Scores Matrix of FIG. 13 may provide the overall Portfolio Risk Score or Portfolio Variance at 1305.

Blocks 902-908 of FIG. 9 and 1001-1014 of FIG. 10 may be executed by aspects of the system of FIG. 8, including, e.g., the RMSS 807 and client terminals 802-804.

When a user is presented a result, the result may be stored in a data store (e.g., RAM or mass storage) of a terminal and/or printed, emailed, transmitted and/or displayed (e.g., on a computer screen).

### Development of Financial Perspective

Implementations of the systems and methods disclosed herein may be useful in the development of a financial perspective that assesses likely outturn of revenue, costs and therefore gross margin as affected by the risk scores. The project risk scores and the portfolio scores may be converted into financial terms using analysis to examine the historical relationship between specific risk scores and changes in costs, revenue and gross margins. Analysis will assist in inferring both directional trends and changes in volatility. Conversion of risk scores to financial terms may also be achieved using expert opinion or Bayesian and other statistical techniques.

For example, Significant Financial Discriminators (SFDs) are identified within the risk factors, based on historical projects. These SFDs can be useful in forecasting change in gross margin percentage and identifying project risk, e.g., the probable changes in revenue and variations in gross margin percentages.

Different SFDs affect the increase in or the decline of predicted revenue. The factors affecting an increase in revenue are not necessarily only the opposites of those shaping a decline. This allows implementations of the systems and methods disclosed herein to predict upsides and downsides that are calculated in appropriately different ways—based on previous product history—rather than being purely statistical variations on the expected.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

A number of embodiments have been described. Nevertheless, it will be understood that various modifications may be made without departing from the spirit and scope of the invention. Accordingly, other embodiments are within the scope of the claims.

What is claimed is:

1. A machine-implemented method of assessing risk associated with a first project, the method comprising:
prompting a user for answers to one or more questions each of which relates to risk of an aspect of the first project; and
generating one or more risk scores indicative of the risk associated with the first project, wherein the one or more risk scores are based on individual risk scores each of which is indicative of risk associated with an individual aspect of the first project and based on compounded risk scores each of which is indicative of a risk associated with an interaction among two or more aspects of the first project.

2. The method of claim 2 wherein the one or more risk scores for the first project are further based on correlated risk scores each of which are indicative of risk associated with an interaction among at least one aspect of the first project and at least one aspect of a second project.

3. The method of claim 1 comprising:
assigning a benchmark value to the first project, wherein the benchmark value represents a typical level of risk associated with the first project; and
graphically displaying an individual risk score or compounded risk score compared to the benchmark value.

4. The method of claim 2 wherein the second project has at least one compounded risk score indicative of risk associated with an interaction among two or more aspects of the second project, the method comprising:
graphically displaying at least one of the compounded risk scores of the first project and at least one of the compounded risk scores of the second project.

5. The method of claim 2 wherein the second project has at least one correlated risk score indicative of risk associated with an interaction among at least one aspect of the second project and at least one aspect of the first project, the method comprising: graphically displaying at least one correlated risk score of the first project and at least one correlated risk score of the second project.

6. A machine-implemented method of assessing the risk of a project, the method comprising:
prompting a user for answers to questions that each relate to the risk of an aspect of a first project;
assigning a numeric comparison value for each question, wherein the comparison value represents a typical level of risk associated with the related aspect;
assigning a numeric response value to the answers to each respective question, wherein the response value is a multiple of the comparison value for the respective question;
receiving an answer from the user for each respective question;
generating ranking scores based on the response value assigned to the answer received from the user for each respective question, wherein the ranking scores represent the level of risk associated with the answer to each respective question relative to each respective comparison value, further wherein the ranking scores for each respective answer are normalized;
generating balanced base scores for each respective ranking score by applying an exponential factor to each respective ranking score;
identifying compound risks within the first project representative of risks associated with a first question in the first project that increase or decrease risks associated with a second question in the first project; and
generating at least one compound risk score for the first project based on the balanced base scores and the compound risks.

7. The method of claim 6 comprising:
prompting a user for answers to questions that each relate to the risk of an aspect of a second project;
identifying compound risks within the second project representative of risks associated with a first question in the second project that increase or decrease risks associated with a second question in the second project;
generating at least one compound risk score for the second project based on the balanced base scores and the compound risks;
identifying correlated risks between questions in the first project and questions in the second project, wherein correlated risks represent risks associated with a question in the second project that increase or decrease risks associated with a question in the first project; and
generating at least one correlated risk score for the first project based on the compound risks scores of the first and second projects and the correlated risks.

8. The method of claim 6 comprising:
assigning a benchmark value to the first project, wherein the benchmark value represents a typical level of risk associated with the first project; and
graphically displaying at least one of the ranking scores, balanced base scores, or compound risk scores compared to the benchmark value.

9. The method of claim 7 comprising graphically displaying at least one compound risk score of the first project and at least one compound risk score of the second project.

10. The method of claim 7 comprising graphically displaying at least one correlated risk score of the first project and at least one correlated risk score of the second project.

11. The method of claim 6 wherein the comparison value has a minimum value of zero.

12. The method of claim 6 wherein generating ranking scores comprises:
normalizing the response value for the answer provided by a user to a first question;
normalizing the comparison value associated with the first question to derive a normalized comparison value (NCV);
dividing the normalized response value by the NCV.

13. The method of claim 12 wherein the applying an exponential factor to each respective ranking score comprises raising at least one ranking score to the power of 1/(1−NCV).

14. The method of claim 6 wherein identifying compound risks among the questions within the first project comprises receiving data from a user.

15. The method of claim 7 wherein identifying compound risks among the questions within the second project comprises receiving data from a user.

16. The method of claim 7 wherein identifying correlated risks between the questions in the first project and questions in a second project comprises receiving data from a user.

17. A system for assessing the risk of a project, the system comprising:
one or more client terminals each associated with a respective user, each client terminal having a respective data store;
one or more risk management servers, operable to communicate with each of the one or more client terminals and further operable to:
communicate with a first client terminal to prompt the respective user for answers to one or more questions each of which relates to risk of an aspect of a first project; and
generate one or more risk scores indicative of the risk associated with the first project, wherein the one or more risk scores are based on individual risk scores each of which is indicative of risk associated with an individual aspect of the first project and based on compounded risk scores each of which is indicative of a risk associated with an interaction among two or more aspects of the first project.

18. The system of claim 17 wherein the one or more risk scores for the first project are further based on correlated risk scores each of which is indicative of risk associated with an interaction among at least one aspect of the first project and at least one aspect of a second project.

19. An article comprising a machine-readable medium that stores machine-executable instructions for causing a machine to:
prompt a user for answers to one or more questions each of which relates to risk of an aspect of a first project; and
generate one or more risk scores indicative of the risk associated with the first project, wherein the one or more risk scores are based on individual risk scores each of which is indicative of risk associated with an individual aspect of the first project and based on compounded risk scores each of which is indicative of a risk associated with an interaction among two or more aspects of the first project.

20. The article of claim 19 comprising instructions for causing a machine to:
generate the one or more risk scores further based on correlated risk scores each of which is indicative of risk associated with an interaction among at least one aspect of the first project and at least one aspect of a second project.

21. A machine-implemented method of assessing the risk of a project, the method comprising:
providing answers to one or more questions each of which relates to risk of an aspect of a first project;
providing answers to one or more questions each of which relates to risk of an aspect of a second project;
receiving one or more risk scores indicative of the risk associated with the first project, wherein the one or more risk scores are based on individual risk scores each of which is indicative of risk associated with an individual aspect of the first project and based on compounded risk scores each of which is indicative of a risk associated with an interaction among two or more aspects of the first project and further based on correlated risk scores each of which is indicative of risk associated with an interaction among at least one aspect of the first project and at least one aspect of the second project.

22. The method of claim 21 comprising:
providing data concerning the interaction among two or more aspects of the first project.

23. The method of claim 21 comprising:
providing data concerning the interaction among at least one aspect of the first project and at least one aspect of the second project.
